(19) United States
(12) Patent Application Publication
(10) Pub. No.: US 2025/0025893 A1
(43) Pub. Date: Jan. 23, 2025

(54) FLUID DELIVERY DEVICE

(71) Applicant: KOHLER MIRA LIMITED, Cheltenham (GB)

(72) Inventor: Leyton Iddon, Cheltenham (GB)

(21) Appl. No.: 18/758,840

(22) Filed: Jun. 28, 2024

(30) Foreign Application Priority Data
Jul. 19, 2023 (GB) 2311088.5

(51) Int. Cl. B05B 1/16; B05B 7/04; E03C 1/04

(52) U.S. Cl. CPC B05B 1/1636; B05B 7/0425; E03C 1/0408

(57) ABSTRACT

A fluid delivery device includes an inlet, fluid delivery outlets, and a switching device between the inlet and the fluid delivery outlets. The switching device cycles between a first operating mode in which fluid flows from the inlet to a first chamber leading to fluid delivery outlets, and a second operating mode in which fluid flows from the inlet to a second chamber leading to fluid delivery outlets. In the first operating mode, the first fluid flow enters a fluid delivery outlet from the first chamber in a first direction and/or at a first location. In the second operating mode, the second fluid flow enters the fluid delivery outlet from the second chamber in a second direction and/or at a second location. The second direction is different from the first direction and/or the second location is different from the first location.

### CROSS-REFERENCE TO RELATED APPLICATIONS

This application claims priority to UK Patent Application No. 2311088.5, filed 19 Jul. 2023, the entirety of which is hereby incorporated by reference.

### FIELD OF THE INVENTION

The present disclosure relates to a fluid delivery device such as a spray head for a shower or a faucet. The present disclosure also relates to a plumbing or ablutionary system comprising such a fluid delivery device.

### BACKGROUND OF THE INVENTION

It is known for fluid delivery devices to be configured to provide multiple different modes of operation (spray modes). Typically, a user may actuate a switching device associated with a fluid delivery device, such as a spray head, to switch between spray modes and alter one or more characteristics of the resultant flow. Introducing multiple spray mode capabilities to a spray head may greatly increase the size, complexity and manufacturing cost of the spray head. The present disclosure aims to provide a compact fluid delivery device capable of operating in multiple different spray modes.

### BRIEF DESCRIPTION OF THE DRAWINGS

There now follows by way of example only a detailed description with reference to the accompanying drawings in which:

FIG. 1 illustrates an exploded view of an example fluid delivery device.

FIG. 2 illustrates a rear view of an example fluid delivery device.

FIG. 3 illustrates an enlarged cross-sectional view of an example fluid delivery device along the line A-A.

FIG. 4 illustrates an enlarged view of a portion of an example fluid delivery device.

FIG. 5 illustrates an enlarged cross-sectional view of an example conduit assembly.

FIG. 6A illustrates an enlarged cross-sectional view of an example conduit assembly in a first operating state.

FIG. 6B illustrates an enlarged cross-sectional view of an example conduit assembly in a second operating state;

FIG. 7A illustrates an example fluid delivery device.

FIG. 7B illustrates a cross-sectional view of an example fluid delivery device.

FIG. 8 illustrates a cross-sectional view of a portion of an example fluid delivery device.

FIG. 9 illustrates a cross-sectional view of a portion of an example fluid delivery device.

FIG. 10 illustrates an example ablutionary system.

### DETAILED DESCRIPTION OF THE DRAWINGS

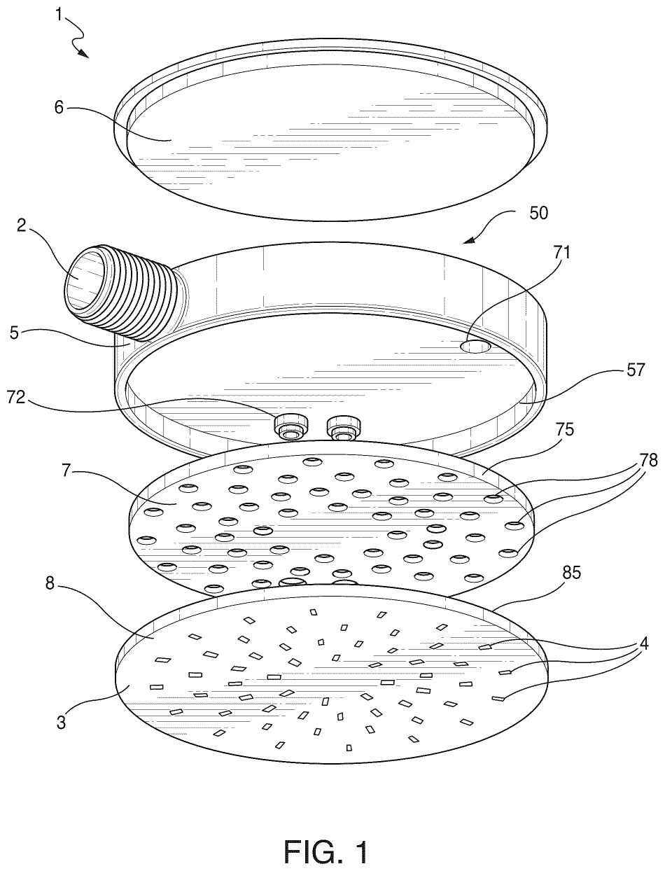

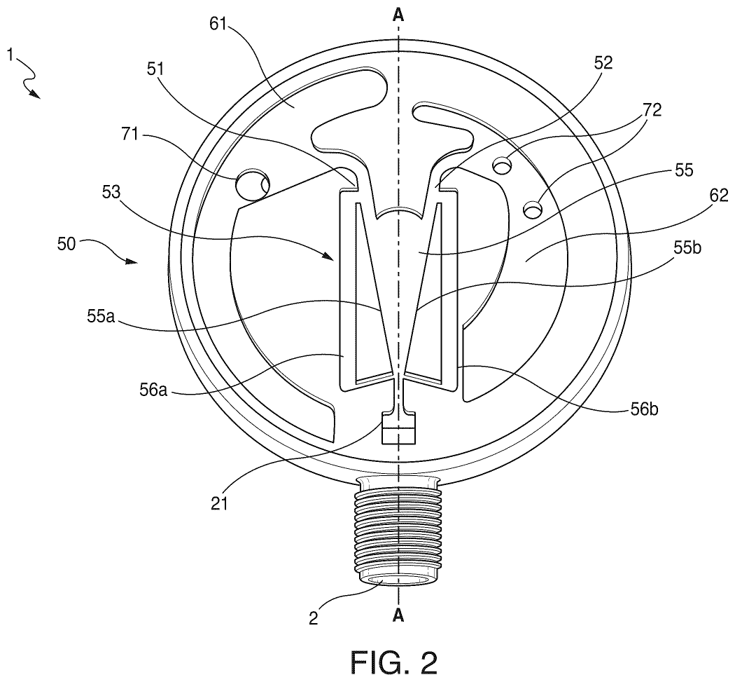

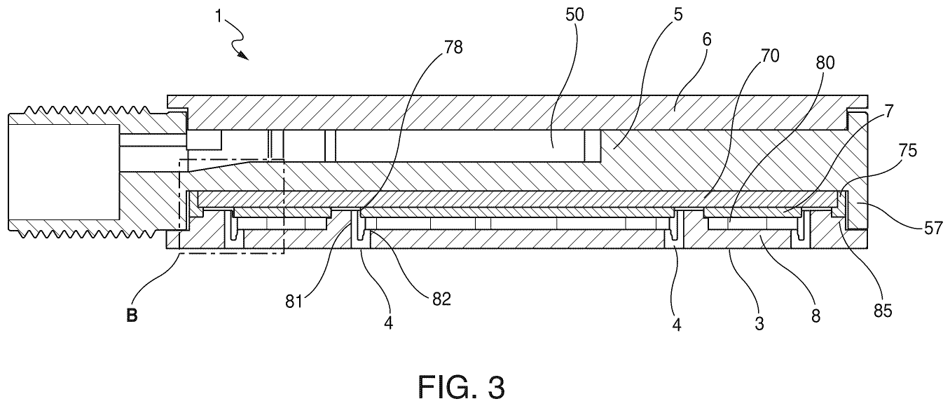

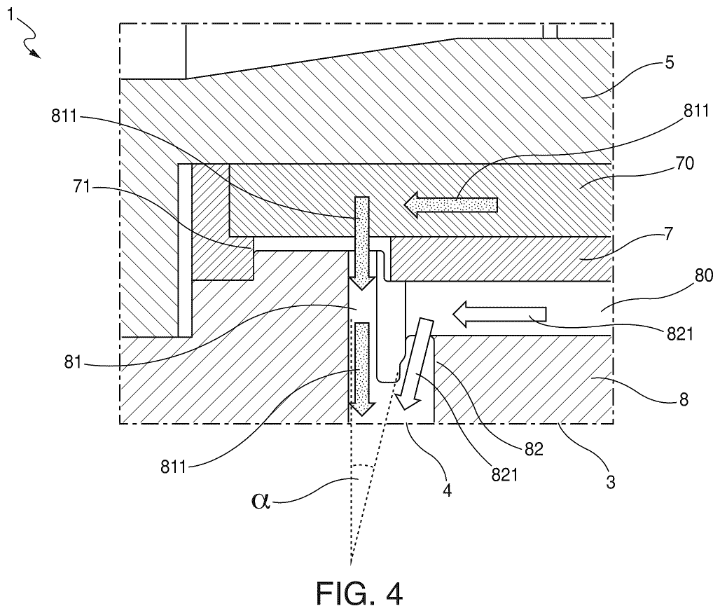

FIG. 1 shows an exploded view of a fluid delivery device 1. FIG. 2 shows a rear view of the fluid delivery device 1 with a cover removed. FIG. 3 shows an enlarged cross-sectional view of the fluid delivery device 1 along the line A-A (FIG. 2). FIG. 4 is an enlarged view of a portion of FIG. 3.

In this example, the fluid delivery device 1 is a spray head for a shower. The fluid delivery device 1 comprises an inlet 2 for receiving fluid from a fluid supply (not shown) and a spray face 3 which includes a plurality of fluid delivery outlets 4. The fluid delivery outlets 4 are preferably in fluid communication with the inlet 2 and a switching device 50 is disposed between the inlet 2 and the fluid delivery outlets 4. The switching device 50 is operable to control fluid flow to the fluid delivery outlets 4 and configured to operate in at least two different operating modes.

In this example, the inlet 2 and the switching device 50 each form part of a single-piece body 5. The body 5 forms a layer of the fluid delivery device 1 that is behind the spray face 3. The inlet 2 is couplable to a fluid supply pipe (not shown) or an adapter thereon (not shown) by means of a screw thread.

The fluid delivery device 1 includes a first plate 7 and a second plate 8. A front surface of the second plate 8 forms the spray face 3. The first plate 7 is disposed between the body 5 and the second plate 8. The first plate 7 has a circumferential flange 75, which projects from the first plate 7 in a direction away from the spray face 3. Similarly, the body 5 has a circumferential flange 57 which projects from the body 5 toward the spray face 3. The flange 75 of the first plate 7 fits within the flange 57 of the body 5, e.g. to form a press fit connection. The second plate 8 is also configured to selectively couple to the body 5 and to the first plate 7 by press fit connections. In this example, a rear surface of the second plate 8 has a stepped edge 85 configured to receive an end part of the flange 57 of the body 5.

A first chamber 70 may be formed between the body 5 and the first plate 7 (see FIG. 3). The first plate 7 contains a first plurality of through holes 78 each of which feed a respective one of the fluid delivery outlets 4 of the spray face 3. A second chamber 80 is formed between the first plate 7 and the second plate 8. The second plate 8 comprises a second plurality of through holes 82 (not shown), each of which fluidically connect the chamber 80 to a respective one of the fluid delivery outlets 4. The second plate 8 further comprises a third plurality of through holes 81 (not shown), each of which fluidically connect a respective one of the first plurality of through holes 78 to a respective one of the fluid delivery outlets 4. The second set 82 and third set 81 of through holes can be seen in FIGS. 3 and 4, the accompanying description of which details their role during operation of the fluid delivery device 1.

As shown in FIG. 1, the fluid delivery device 1 further comprises a cover 6 which forms a rear external surface of the fluid delivery device 1 opposite the spray face 3. In this example, the cover 6 acts to seal a rear face of the switching device 50. The cover 6 is selectively couplable to a rear of the body 5 via a press fit connection.

FIG. 2 shows a rear view of the fluid delivery device 1 with the cover 6 removed. As shown in FIG. 2, the switching device 50 comprises a switching device inlet 21, a switching mechanism 53 and at least two switching device outlets. In this example, the switching device 50 includes a first switching device outlet 51 and a second switching device outlet 52, which each feed a respective one of the first chamber 70 and the second chamber 80. The body 5 comprises a first plenum 61 which fluidically connects the first switching device outlet 51 to a first passage 71 in the body 5. The first passage 71 comprises an aperture which fluidically connects the first plenum 61 of the body 5 to the first chamber 70.

The body 5 comprises a second plenum 62 which fluidically connects the second switching device outlet 52 to two second passages 72 in the body 5. Each of the two second passages 72 projects through the full thickness of the first chamber 70 and fluidically connects the second plenum 62 of the body 5 to the second chamber 80. The passages 72 may be tube-shaped, though other shapes are foreseeable.

The switching device 50 is configured to operate in a first operating mode and a second operating mode. In the first operating mode, fluid is fed from the first switching device outlet 51 through the first plenum 61 to the first passage 71 and on into the first chamber 70. In the second operating mode fluid is fed from the second switching device outlet 52 through the second plenum 62 to the second passages 72 and on into the second chamber 80.

The switching device 50 is configured to cycle continuously (or substantially continuously) between the first operating mode and the second operating mode.

As shown in FIG. 2, the switching mechanism 53 comprises an antechamber 55 having a generally triangular shape. The switching device inlet 21 fluidically connects the inlet 2 to the antechamber 55 at or around its apex. The first switching device outlet 51 and the second switching device outlet 52 connect to a basal edge of the antechamber 55 (on opposite sides of the antechamber 55). In this example, the first switching device outlet 51 and the second switching device outlet 52 connect to the antechamber 55 at opposite ends of the basal edge.

The switching mechanism 53 may further comprise a first feedback loop 56a which provides a path for fluid flow from the first switching device outlet 51 to the antechamber 55. The switching mechanism 53 also may comprise a second feedback loop 56b which provides a path for fluid flow from the second switching device outlet 52 to the antechamber 55.

The first feedback loop 56a and the second feedback loop 56b may be connected to opposing sides of the antechamber 55, termed a first side 55a and a second side 55b respectively. The first side 55a and the second side 55b of the antechamber 55 may be segregated along dashed line A-A by a normal line to the basal plane that is projecting though the apex of the antechamber 55. The first feedback loop 56a is connected to a non-basal edge of the antechamber 55, such that the first feedback loop 56a and the first switching device outlet 51 are both connected to the first side 55a of the antechamber 55. Similarly, the second feedback loop 55b is connected to a further non-basal edge of the antechamber 55, such that the second feedback loop 56b and the second switching device outlet 52 are both connected on the second side 55b of the antechamber 55. In this example, both the first feedback loop 56a and the second feedback loop 56b are connected to the antechamber 55 near its apex.

In this example, the first feedback loop 56a and the second feedback loop 56b follow an angular path bounded by straight edges. However, it is within the scope of this disclosure that their paths be any suitable conformation such as meandering curved paths. As shown in FIG. 2, the first feedback loop 56a may be a mirror image of the second feedback loop 56b relative to a dashed line A-A. In other implementations, the first feedback loop 56a and the second feedback loop 56b may not be mirror images of each other. The first feedback loop 56a and the second feedback loop 56b may be substantially identical to each other or may be different from each other.

The first feedback loop 56a is preferably configured such that fluid flow from the first feedback loop 56a enters the antechamber 55 in a direction pointing substantially towards the second side 55b of the antechamber 55. The second feedback loop 56b is preferably configured such that fluid flow from the second feedback loop 56b enters the antechamber 55 in a direction pointing substantially towards the first side 55a of the antechamber 55. This configuration may permit flow from the first feedback loop 56a to disrupt flow to the first switching device outlet 51. Similarly, the flow from the second feedback loop 56b may disrupt flow from the antechamber 55 to the second switching device outlet 52. In this way, the switching device 50 is configured to function as described below.

The switching device 50 has a first operating mode and a second operating mode. In the first operating mode, fluid enters the antechamber 55 through the switching device inlet 21 and is directed through the antechamber 55 to the first switching device outlet 51 to form a first fluid flow. Fluid flow through the first switching device outlet 51 drives a portion of flow through the first feedback loop 56a and back into the antechamber 55. This disrupts the flow from the switching device inlet 21 to the first switching device outlet 51, thereby switching the switching device 50 into its second operating mode. Fluid flow through the second switching device outlet 52 drives a portion of flow through the second feedback loop 56b and back into the antechamber 55.

In the second operating mode, fluid enters the antechamber 55 through the switching device inlet 21 and is directed through the antechamber 55 to the second switching device outlet 52 to form a second fluid flow. This disrupts the flow from the switching device inlet 21 to the second switching device outlet 52, thereby switching the switching device 50 back into its first operating mode. In this way, during use of the fluid delivery device 1, the switching device 50 is caused to continuously (or substantially continuously) cycle between the first operating mode and the second operating mode.

In this way, the fluid delivery device 10 does not rely on any moving parts to cycle between the first operating mode and the second operating mode. Alternate switching mechanism for cycling between the first operating mode and the second operating mode are considered within the scope of this disclosure. For example, a rotating turbine element could be used in place of the switching mechanism 53 to alternatingly fluidically couple the first and second switching device outlets 51, 52 to the switching device inlet 21.

FIG. 3 shows an enlarged cross-sectional view of the fluid delivery device of FIGS. 1 and 2 along the line A-A (FIG. 2). The path of the first fluid flow and the second fluid flow from the first and second chambers respectively to the fluid delivery outlets 4 is best shown by FIGS. 3 and 4.

FIG. 4 shows an enlarged view of a portion of FIG. 3 (indicated in FIG. 3 by dashed box ‘B’). As shown in FIGS. 3 and 4, the first chamber 70 is farther from the spray face 3 than the second chamber 80 when measured from a centre of volume of the first chamber 70 and a centre of volume of the second chamber 80, respectively. Advantageously, having the first and second chamber 70, 80 vertically offset from one another may enable fluid to be laterally distributed across the spray head without mixing of the first and second fluid flows. This may have benefits over conventional fluid distribution arrays wherein complex pathways are used to segregate different flows within a single layer.

As shown in FIGS. 3 and 4, the fluid delivery outlets 4 may be supplied by a respective pair of through holes (one of the second plurality of the through holes 82 and one of the third plurality of through holes 81).

The first plurality of through holes 78 (in the first plate 7) may feed a respective one of the third plurality of through holes (in the second plate 8). This prevents mixing of the first fluid flow from the first chamber 70 with the second fluid flow from the second chamber 80, effectively enabling the first fluid flow to reach the fluid delivery outlets 4 while bypassing the second chamber 80. When the switching device 50 is in the first operating mode, fluid travels from the first chamber 70 to the fluid delivery outlets 4 via the first plurality of through holes 71 and the third plurality of through holes 82. This first fluid flow is represented by black block arrows 811 in FIG. 4.

The second fluid flow, i.e., flow from the second chamber 80 to one of the fluid delivery outlets 4, is shown by white block arrows 821 in FIG. 4. In the second operating mode, fluid travels from the second chamber 80 to the fluid delivery outlets 4 via the second plurality of through holes 82 of the second plate 8. Cycling between operating modes of the switching device 50 switches which of the first fluid flow and the second fluid flow supplies the fluid delivery outlets 4.

For each given fluid delivery outlet 4: when the switching device is in the first operating mode, the first fluid flow enters the fluid delivery outlet 4 at a first location; and when the switching device is in the second operating mode, the second fluid flow enters the given fluid delivery outlet 4 at a second location. Furthermore, each of the second plurality of through holes 82 may be tilted, by an angle a, with respect to the third plurality of through holes 81 such that for each given fluid delivery outlet 4, the first fluid flow enters the fluid delivery outlet 4 in a different direction from that which the second fluid flow enters the fluid delivery outlet 4. The angle α may be greater than or equal to 2°, greater than or equal to 5°, greater than or equal to 10°, greater than or equal to 15°, greater than or equal to 20° or greater than or equal to 30° and/or less than or equal to 10°, less than or equal to 15°, less than or equal to 20°, less than or equal to 30° or less than or equal to 40°.

In this example, the third plurality of through holes 81 is substantially cylindrical in shape with longitudinal axes perpendicular to the spray face 3. The second plurality of through holes 82 may widen towards the spray face 3 to form an oblique frustoconical shape. The axes of the oblique frustoconical shapes may not be parallel to the longitudinal axes of the third plurality of through holes 81. For each pair of through holes, the angle between the one of the third plurality of through holes 81 and the one of the second plurality of through holes 82 may be greater than or equal to 2°, greater than or equal to 5°, greater than or equal to 10°, greater than or equal to 15°, greater than or equal to 20° or greater than or equal to 30° and/or less than or equal to 10°, less than or equal to 15°, less than or equal to 20°, less than or equal to 30° or less than or equal to 40°. In this example, the angle between the one of the third plurality of through holes 81 and the one of the second plurality of through holes 82 is approximately 23°.

Configuring the fluid delivery device 1 in this way may advantageously allow for unconventional output flow characteristics to be produced. Such switching flow from different locations and/or in different directions may result in output flow from the spray face 3 that mimics rainfall to at least some extent. In general, a user may be provided with an unconventional and/or novel showering experience.

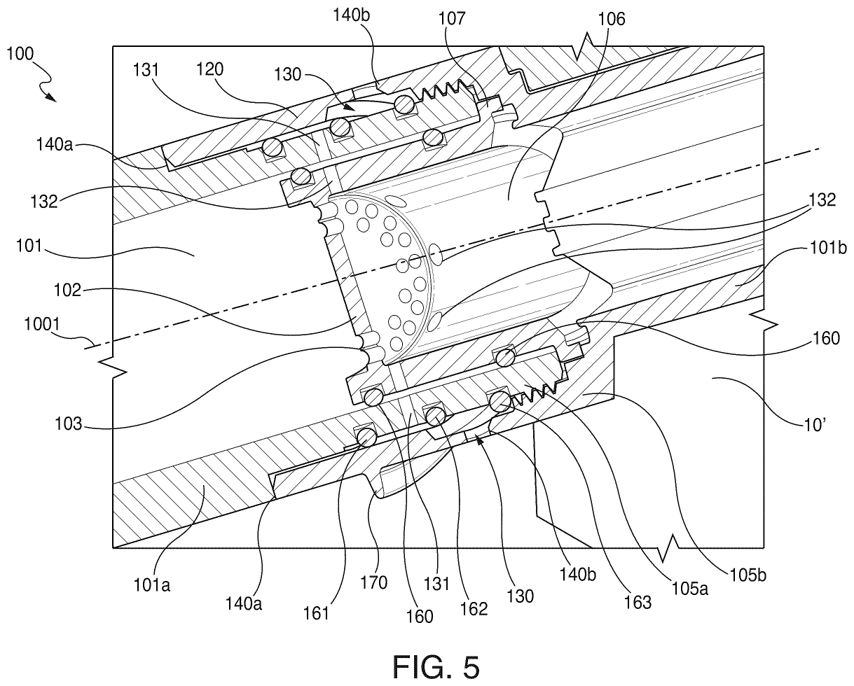

Referring to FIGS. 5, 6A, 6B, 7A and 7B, an enlarged cross-sectional view of a conduit assembly 100 for a fluid delivery device is shown. The conduit assembly 100 includes a conduit 101 configured to convey a fluid stream.

The conduit assembly 100 further includes a flow constrictor 102 configured to constrict flow of the fluid stream along the conduit 101, thereby producing, in use, a pressure drop in the fluid stream downstream of the flow constrictor 102.

The flow constrictor 102 is arranged within the conduit 101. The flow constrictor 102 comprises a disc, perpendicular (or substantially perpendicular) to a longitudinal axis 1001 of the conduit 101 and perforated by a plurality of apertures 103. In this example, the plurality of apertures 103 includes 32 apertures arranged in two rings proximal to a perimeter of the disc.

As a total flow area through the plurality of apertures 103 is substantially less than a flow area of the conduit 101, in use, the flow constrictor 102 produces a pressure drop in the fluid stream downstream of the flow constrictor 102. Other flow constrictor configurations that may be employed without departing from the scope of this disclosure will be readily apparent to a person skilled in the art. The flow constrictor may have any suitable configuration to produce a pressure drop in the fluid stream downstream thereof.

The conduit 101 may be made from two generally tubular parts: a first part 101a and a second part 101b which are configured to selectively couple to one another. In this example, the first part 101a is upstream of the second part 101b. An end of the first part 101a proximal to the second part 101b may have a reduced radius portion 105a which has a smaller external radius than a remainder of the first part 101a. A threaded portion may be disposed on an external surface of the reduced radius portion 105a. An end of the second part 101b proximal to the first part 101a may have an increased radius portion 105b which has a larger internal radius than a remainder of the second part 101b. A threaded portion may be disposed on an internal surface of the increased radius portion 105b. The reduced radius portion 105a of the first part 101a is preferably configured to fit at least partially within and threadingly engage with the increased radius portion 105b to selectively couple the first and second parts 101a, 101b of the conduit 101. A sealing member 163 having the form of an O-ring is configured to provide a fluid-tight (or nearly fluid-tight) seal between the first part 101a and the second part 101b of the conduit 101.

The flow constrictor 102 may form one end of a hollow insert 106 which sits within the reduced radius portion 105a of the first part 101a. The hollow insert 106 can include a radially projecting rim 107 distal from the flow constrictor 102. The rim 107 may be positioned between the reduced radius portion 105a of the first part 101a and the second part 101b. This configuration helps prevent translation of the hollow insert 106 along the conduit 101.

The conduit assembly 100 further comprises eight air induction channels 130 for conveying a stream of air from outside the conduit 101 into the conduit 101, though more or fewer channels 130 are foreseeable. The eight air induction channels 130 are distributed substantially evenly around a circumference of the conduit 101. In this example, each one of the eight air induction channels 130 includes a one of a first set of air induction passages 131 which perforate the first part 101a of the conduit 101 and one of a second set of air induction passages 132 which perforate the hollow insert 106.

The first set of air induction passages 131 includes eight air induction passages regularly spaced around a circumference of the reduced radius portion 105a. The second set of air induction passages 132 includes eight air induction channels regularly spaced around a circumference of the hollow insert 106 proximal to the flow constrictor 102. The second set of air induction passages 132 may be arranged to receive air from a respective one of the first set of air induction passages 131 and provide air to an interior of the hollow insert 106.

Sealing members 160 may be disposed on an external surface of the hollow insert 106 on either side of the second set of air induction passages 132. In the examples shown in the figures, each of the sealing members, such as sealing members 160 of the conduit assembly 100, is an O-ring, though other sealing members are foreseeable. The sealing members 160 help reduce or prevent fluid leaking from within the conduit assembly 100 along the first set of air induction passages 131 to outside the conduit assembly 100. Equally, the sealing members 160 also act to help reduce or prevent air from entering the conduit assembly 100 upstream of the flow constrictor 102.

The conduit assembly 100 is configured such that air may enter the hollow insert 106 immediately downstream of the flow constrictor 102. At this point, in the conduit 101 there may be a pressure drop, and fluid flow is at a high velocity. This may aid air to be drawn along the air induction channels 130 and achieve effective mixing of the air into the fluid stream creating an aerated fluid stream.

The applicant has appreciated that it may be beneficial to allow selection between different flow characteristics of a fluid delivery device in which the conduit assembly is integrated. To this end, the conduit assembly 100 comprises an air induction channel closure means operable to actuate the conveyance of air along the air induction channels 130. In the illustrated example, the air induction channel closure means comprises a sleeve 120 operable to translate, relative to the conduit 101, parallel to the longitudinal axis 1001 of the conduit 101. The sleeve 120 is substantially tubular in shape and surrounds an outer circumference of the reduced radius portion 105a. An inner radius of the sleeve 120 is just greater than an outer radius of the reduced radius portion 105a to produce a close fit between the two pieces. An outer radius of the sleeve 120 is substantially equal to: an outer radius of the remainder of the first part 101a; and the increased radius portion 105b. In this way, the sleeve 120 sits flush (or nearly flush) with the first part 101a and the second part 101b of the conduit 101.

A step is formed at the junction between the reduced radius portion 105a and the remainder of the first part 101a. The step forms a first contact surface 140a for interaction with the sleeve 120 and acts as an end stop for translation of the sleeve 120 in a first direction 151. An end face of the increased radius portion 105b, proximal to the first part 101a, forms a second contact surface 140b for interaction with the sleeve 120 and acts as an end stop for translation of the sleeve 120 in a second direction 152, substantially opposite the first direction 151. The sleeve 120 is operable to translate between two end points determined by the first end stop and the second end stop respectively, which define first and second states of the air induction channel closure means respectively.

The sleeve 120 further may comprise a ridge 170 which enables user actuation of the sleeve 120 between the states of the sleeve 120. The ridge 170 projects away from the conduit 101. The ridge 170 may be substantially arcuate in shape, e.g., providing a crescent (or similar shape) configured to fit a user's thumb.

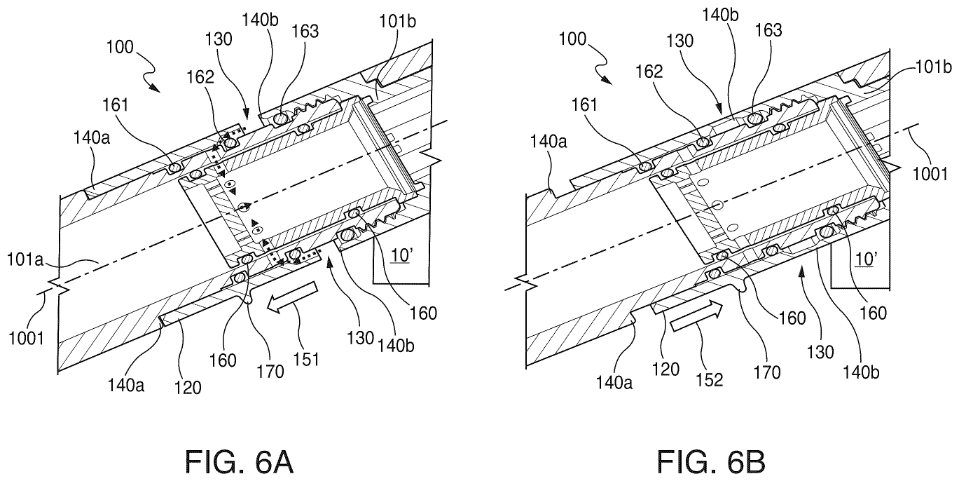

FIG. 6A shows the conduit assembly 100 wherein the sleeve 120 is in the first state. In this state, a rear end of the sleeve 120 contacts the first contact surface 140a of the first part 101a. A front end of the sleeve 120 does not contact the second contact surface 140b of the second part 101b. As such, a gap is present between the front end of the sleeve 120 and second part 101b opening up the air induction channels 130. Two sealing members 161, 162 are preferably disposed on an external surface of the reduced radius portion 105a on either side of the first set of air induction passages 131. A first of these two sealing members 161, distal to the second part 101b, acts to help prevent air from entering the conduit 101 via the gap between the rear end of the sleeve 120 and first contact surface 140a. An internal radius of sleeve 120 increases towards the front end of the sleeve 120. In this configuration in the first state, there is preferably clearance between a second of the two sealing members 162 and the sleeve 120. In this state, the pressure drop in the fluid stream downstream of the flow constrictor 102 may cause air to be drawn through the open air induction channels 130 to mix with the fluid stream in the hollow insert 106 to form the aerated fluid stream. The flow of air through the air induction channels 130 is shown by dotted arrows in FIG. 6A.

FIG. 6B shows the conduit assembly 100 wherein the sleeve 120 is in the second state. In this state, the front end of the sleeve 120 contacts the second contact surface 140b of the second part 101b, sealing the front end of the sleeve 120 against the second part 101b. As such, the air induction channels 130 are closed and no (or substantially no) streams of air may be conveyed along the closed air induction channels 130 from outside the conduit 101 into the conduit 101. In this state, the fluid stream downstream of the flow constrictor 102 is not an aerated fluid stream. A gap is present between the rear end of the sleeve 120 and first contact surface 140a of the first part 101a. In this configuration, the two sealing members 161, 162 may inhibit fluid (e.g., air or water) traversing between the reduced radius portion 105a and the sleeve 120. The second sealing member 162, proximal to the second part 101b, acts to help prevent air from entering the conduit 101 between the front end of the sleeve 120 and the second contact surface 140a.

In an alternate configuration (not shown in the Figures), the sealing member 162 may instead be disposed on the internal surface of the sleeve 120 and a groove may be provided in the reduced radius portion 105a of the first part 101a. In this alternate configuration, the groove may be configured: to align with the sealing member 162 when the sleeve is in its first state to provide clearance between the sealing member 162 and the reduced radius portion 105a; and to be mis-aligned with the sealing member 162 when the sleeve is in its second state such that there is not clearance between the sealing member 162 and the reduced radius portion 105a.

The sleeve 120 may have one or more intermediate states between the first and second states. In such intermediate states, a small gap may be present between the interior surface of the sleeve 120 and the sealing member 162. When the sleeve 120 is positioned as such, the air induction channels 130 may be considered to be partially open and the resultant fluid stream may be aerated to a lesser extent than when the sleeve is in the first state. Provision of such intermediate states may allow a user finer control over the extent of aeration of the fluid stream.

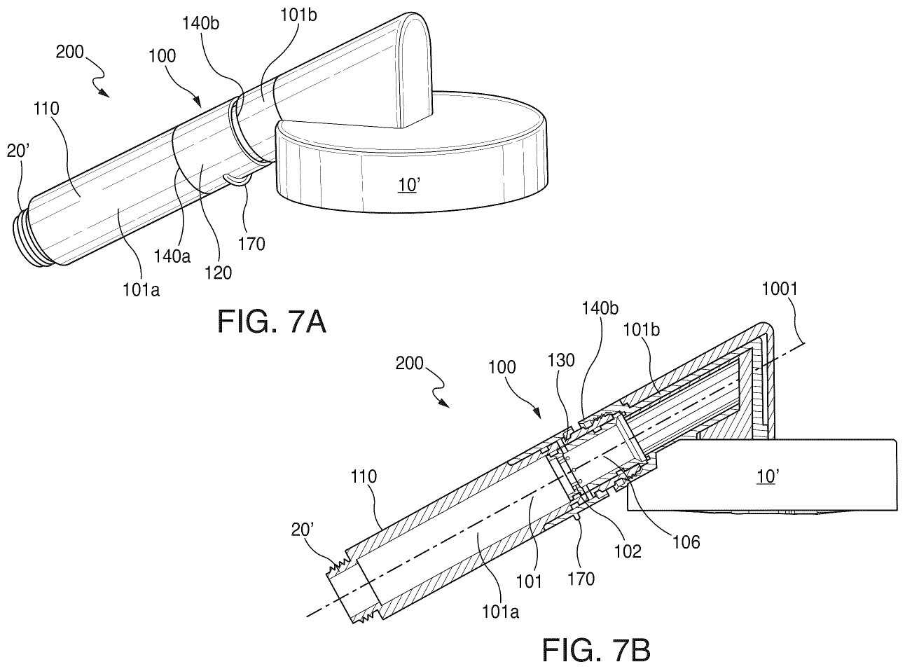

FIG. 7A shows a fluid delivery device 200 including the conduit assembly 100. FIG. 7B shows a cross-sectional view of the fluid delivery device 200.

The fluid delivery device 200 may comprise a handset for a shower including a handle portion 110 and a head portion 10′.

A first end of the handle portion 110 may comprise a threaded portion for connecting the handle portion 110, in use, to a fluid supply pipe (not shown). The handle portion 110 may include the conduit assembly 100 which enables selection between different flow characteristics of a fluid delivery device 200.

In this example, the conduit 101 is configured to convey a fluid stream through the handle portion 110 towards the head portion 10′. An inlet 20′ of the conduit assembly 100 is located at the first end of the handle portion 110.

The head portion 10′ may include one or more internal chambers (not shown) in fluid communication with the conduit 101 and a spray face with a plurality of outlets for delivering fluid, in use, to a user. The head portion 10′ may include any suitable head portion of a handset for a shower.

In FIGS. 7A and 7B, the fluid delivery device 200 is shown while the sleeve 120 is in the first state. In this state, the rear end of the sleeve 120 preferably contacts the first contact surface 140a of the first part 101a. The front end of the sleeve 120 preferably does not contact the second contact surface 140b of the second part 101b. As such, a gap may be present between the front end of the sleeve 120 and second part 101b opening up the air induction channels 130. In this state, flow to the head portion 10′ is aerated by the conduit assembly 100.

Conventional actuation means, such as those that rely on relative rotation of two parts, can cause difficulty for a user whose hands are likely to be wet. Typically, such rotational actuation requires two hands, with one hand being used to secure each part. In contrast, for the present example, actuation can be achieved by user-controlled translation of the sleeve 120 with respect to the conduit 101 (with grip aided by ridge 170). Due to the positioning of the sleeve 120 on the handle portion 110 of the fluid delivery device 10′ and the provision of the ridge 170 to aid grip, a user may actuate the conduit assembly 100 with a single hand using their palm and fingers to grasp the handle portion 110 and their thumb to slide sleeve 120. In this way, the conduit 101 may provide an aerating means that can be actuated by a user without undue complexity (which may result in high manufacturing costs).

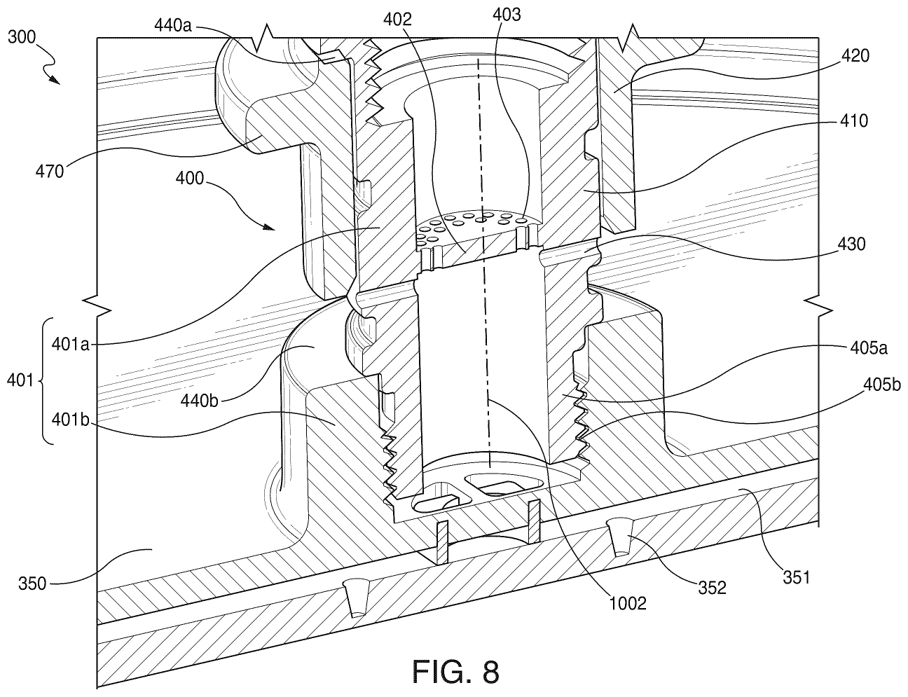

FIG. 8 shows a cross-sectional view of a fluid delivery device 300. The fluid delivery device 300 comprises a spray head 350 for a shower and operates in a similar fashion to the fluid delivery device 200 of FIGS. 7A and 7B. Similarly to the fluid delivery device 200 of FIGS. 7A and 7B, the fluid delivery device 300 comprises a conduit assembly 400.

The conduit assembly 400 is preferably configured to couple to a fluid supply pipe (not shown) and the spray head 350. The spray head 350 may include one or more internal chambers 351 in fluid communication with the conduit assembly 400 and a spray face with a plurality of outlets 352 for delivering fluid, in use, to a user.

The main difference between these devices is that the fluid delivery device 300 is a fixed overhead shower while the fluid delivery device 200 is a handheld shower. As shown in FIG. 8, the conduit assembly 400 may be integrated into a support pipe 410 that fixes the fluid delivery device 300 with respect to a shower enclosure in which the fluid delivery device 300 is installed. This is in contrast to the fluid delivery device 300 shown in FIGS. 7A and 7B where the conduit assembly 100 forms part of the handle 110.

The conduit assembly 400 may include a conduit 401 configured to convey a fluid stream from the fluid supply pipe to the spray head 350. The conduit 401 is preferably made from two generally tubular parts: a first part 401a and a second part 401b which are configured to selectively couple to one another. In this example, the first part 401a is upstream of the second part 401b and configured to couple to a fluid supply pipe. An end of the first part 401a proximal to the second part 401b has a reduced radius portion 405a which may have a smaller external radius than a remainder of the first part 401a. A threaded portion can be disposed on an external surface of the reduced radius portion 405a. A threaded portion 405b can be disposed on an internal surface of the second part 401b. The reduced radius portion 405a of the first part 401a is configured to fit at least partially within and threadingly engage with threaded portion 405b of the second part 401b to selectively couple the first and second parts 401a, 401b of the conduit 401.

The first part 401a may include a flow constrictor 402 configured to constrict flow of the fluid stream along the conduit 401, thereby producing, in use, a pressure drop in the fluid stream downstream of the flow constrictor 402. The flow constrictor 402 comprises a disc, perpendicular (or substantially perpendicular) to a longitudinal axis 1002 of the conduit 401, perforated by a plurality of apertures 403. In this example, the plurality of apertures 403 includes 32 apertures arranged in two rings proximal to a perimeter of the disc.

As a total flow area through the plurality of apertures 403 is less than a flow area of the conduit 401, in use, the flow constrictor 402 produces a pressure drop in the fluid stream downstream of the flow constrictor 402. Other flow constrictor configurations that may be employed without departing from the scope of this disclosure will be readily apparent to a person skilled in the art. The flow constrictor may have any suitable configuration to produce a pressure drop in the fluid stream downstream thereof.

The first part 401a further can comprise a plurality of air induction channels 430 for conveying a stream of air from outside the conduit 401 into the conduit 401. The air induction channels 430 may be distributed substantially evenly around a circumference of the conduit 401.

The conduit assembly 400 is preferably configured such that air may enter the conduit 401 downstream of the flow constrictor 402. At this point, in the conduit 401 there is a pressure drop, and fluid flow is at a high velocity. This may beneficially help draw air along the air induction channels 430 and achieve effective mixing of the air into the fluid stream, creating an aerated fluid stream.

The conduit assembly 400 comprises an air induction channel closure means operable to actuate the conveyance of air along the air induction channels 430. In the illustrated example, the air induction channel closure means comprises a sleeve 420 operable to translate, relative to the conduit 401, parallel to the longitudinal axis 1002 of the conduit 401. The sleeve 420 is substantially tubular in shape and surrounds an outer circumference of the first part 401a. An inner radius of the sleeve 420 is just greater than an outer radius of the first part 401a to produce a close fit between the two pieces.

A step may be formed on the outer surface of the first part 401a which forms a first contact surface 440a for interaction with the sleeve 420 and acts as an end stop for translation of the sleeve 420 in a first direction. Another step may be formed at the junction between the first part 401a and the second part 401b, which forms a second contact surface 440b for interaction with the sleeve 420. The second contact surface 440b acts as an end stop for translation of the sleeve 420 in a second direction, substantially opposite the first direction. The sleeve 420 may be operable to translate between two end points determined by the first end stop and the second end stop respectively, which define first and second states of the air induction channel closure means respectively.

The sleeve 420 further comprises a ridge 470 which enables user actuation of the sleeve 420 between the states of the sleeve 420. The ridge 470 preferably projects away from the conduit 401 around a circumference of the sleeve 420.

FIG. 8 shows the conduit assembly 300 wherein the sleeve 420 is in the first state. In this state, a rear end of the sleeve 420 may contact the first contact surface 440a of the first part 401a. A front end of the sleeve 420 does not contact the second contact surface 440b of the second part 401b. As such, a gap may be present between the front end of the sleeve 420 and second part 401b, opening up the air induction channels 430.

When the sleeve 420 is in the second state, the front end of the sleeve 420 may contact the second contact surface 440b of the second part 401b, sealing (or substantially sealing) the front end of the sleeve 420 against the second part 401b. As such, in this state, the air induction channels 430 may be closed such that no (or very few) streams of air may be conveyed along the closed air induction channels 430 from outside the conduit 401 into the conduit 401. The fluid stream downstream of the flow constrictor 402 is not an aerated fluid stream. A gap may be present between the rear end of the sleeve 420 and first contact surface 440a of the first part 401a.

Sealing members (not shown), such a O-rings, can be disposed on an external surface of the first part 401a on either side of the air induction channels 430. The sealing members may help prevent air from entering the conduit assembly 300 when the sleeve 420 is in the second state.

Conventional actuation means, such as those that rely on relative rotation of two parts, can cause difficulty for a user whose hands are likely to be wet. Typically, such rotational actuation requires two hands, with one hand being used to secure each part. In contrast, for the present example, actuation can be achieved by user-controlled translation of the sleeve 420 with respect to the conduit 401 (with grip aided by ridge 470). In this way, the conduit assembly 400 may provide an aerating means that can be actuated by a user without undue complexity (which may result in high manufacturing costs).

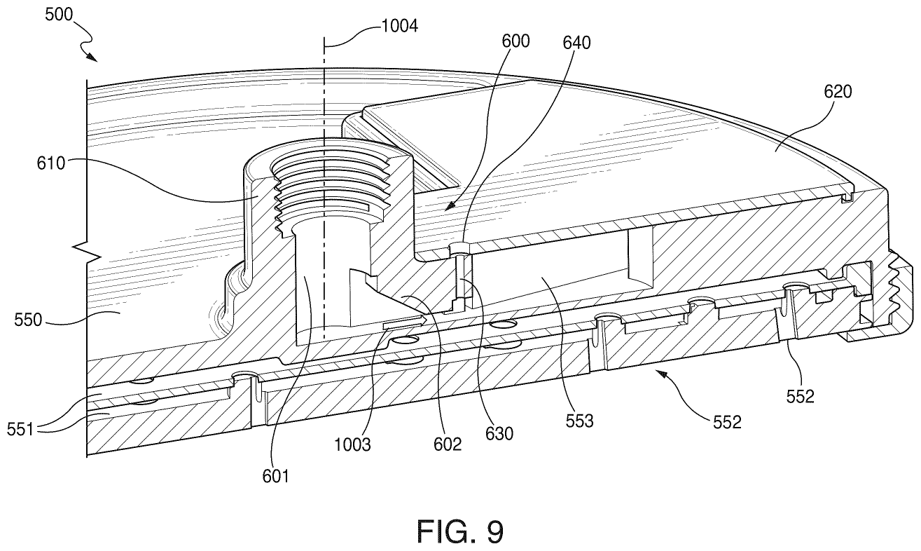

FIG. 9 illustrates a cross-section view of a fluid delivery device 500. The fluid delivery device 500 may comprise a spray head 550 for a shower and operates in a similar fashion to the fluid delivery device 300 of FIG. 8. The fluid delivery device 500 comprises a conduit assembly 600 which is configured to couple to a fluid supply pipe (not shown).

In this example, the spray head 550 may include a switching device 553 similar to the switching device 50 of FIGS. 1 to 3. The spray head 550 can further comprise: one or more internal chambers 551 in fluid communication with the switching device 553; and a spray face 554 with a plurality of outlets 552 for delivering fluid from the one or more internal chambers 551 to a user. The conduit assembly 600 may be integrated into and completely housed within the spray head 550. As in previous embodiments, the conduit assembly 600 is operable to selectively aerate flow travelling therethrough.

As will be described below, the conduit assembly 600 is configured differently to the conduit assembly 400 of FIG. 8. For example, the air induction channel closure means of the conduit assembly 400 comprises the sleeve 420, while the air induction channel closure means of the conduit assembly 600 does not comprise a sleeve and aeration of flow is instead actuated via rotation of a movable plate 620.

The conduit assembly 600 includes a conduit 601. The conduit 601 is configured to convey a fluid stream from the fluid supply pipe to the switching device 553.

The conduit assembly 600 includes a flow constrictor 602 configured to constrict flow of the fluid stream along the conduit 401, thereby producing, in use, a pressure drop in the fluid stream downstream of the flow constrictor 602. The flow constrictor 602 comprises section of the conduit 601 wherein a cross-sectional area progressively narrows in a direction 1003 of the fluid stream. Other flow constrictor configurations that may be employed without departing from the scope of this disclosure will be readily apparent to a person skilled in the art. The flow constrictor may have any suitable configuration to produce a pressure drop in the fluid stream downstream thereof.

Downstream of the flow constrictor 602, the conduit 601 is perforated by one or more air induction channels 630 for conveying a stream of air from outside the conduit 601 into the conduit 601. At this point, in the conduit 601 there is a pressure drop and fluid flow is at a high velocity. This may beneficially ensure air is drawn along the one or more air induction channels 630 and achieve effective mixing of the air into the fluid stream creating an aerated fluid stream.

As mentioned previously, the conduit assembly 600 comprises an air induction channel closure means operable to actuate the conveyance of air along the one or more air induction channels 630. In the illustrated example, the air induction channel closure means comprises a movable plate 620 which forms a rear external surface of the spray head 550. The movable plate 620 is operable to move with respect to the one or more air induction channels 630. In this example, the movable plate 620 is operable to rotate around an axis 1004 of the fluid delivery device 500 with respect to a remainder of the fluid delivery device 500 upon user actuation. The axis 1004 passes through and is aligned substantially perpendicular to a center of the spray face 554.

The movable plate 620 can be perforated with one or more through thickness apertures 640 arranged to selectively align with the one or more air induction channels 630.

The movable plate 620 may be operable to be actuated between a first state and a second state. FIG. 9 shows the conduit assembly 600 wherein the movable plate 620 is in the first state. In this state, the movable plate 620 is arranged such that the one or more through thickness apertures 640 at least partially align with the one or more air induction channels 630 thereby enabling airflow to the one or more air induction channels 630. As such, in this state, the air induction channels 630 open and air may be conveyed along the one or more air induction channels 630 from outside the conduit 601 into the conduit 601. In this state, the fluid stream downstream of the flow constrictor 602 said to be an aerated fluid stream.

When the movable plate 620 is arranged in the second state, the one or more through thickness apertures 640 are misaligned with the one or more air induction channels 630 thereby preventing or reducing airflow to the one or more air induction channels 630. As such, in this state, the one or more air induction channels 630 are closed (or substantially closed) such that air cannot be conveyed (or is limited) along the one or more air induction channels 630 from outside the conduit 601 into the conduit 601. As a result, in this state, the fluid stream downstream of the flow constrictor 602 is not an aerated fluid stream.

The movable plate 620 may include a grip (not shown) to enable user actuation of the movable plate 620 between the first state and the second state. This configuration may allow the moveable plate to be set in either the first sate or the second state during assembly thereby limiting the number of different components required to produce spray heads with different resultant flow characteristics.

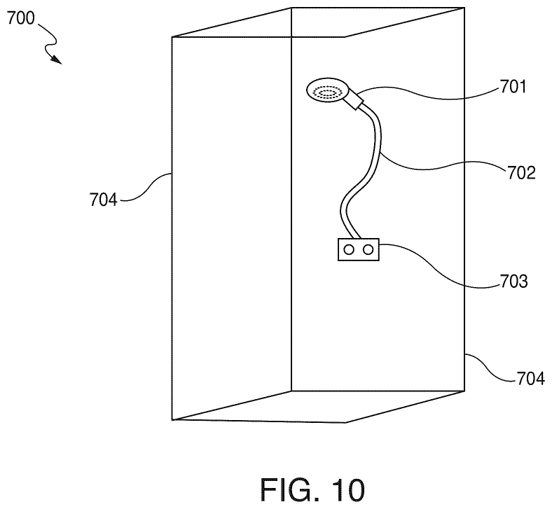

FIG. 10 shows an ablutionary system 700 comprising a fluid delivery device 701. The fluid delivery device 701 may be any suitable fluid delivery device within the scope of this disclosure such as the fluid delivery device 1 or the fluid delivery device 200. The ablutionary system 700 further comprises a fluid supply pipe 702 fluidically connected to the fluid delivery device 701. The fluid supply pipe 702 may be releasably connected to the fluid delivery device 701 by any suitable means, such as co-operating screw threads or snap fit connectors. The fluid supply pipe 702 is configured to supply fluid from a fluid source such as a mixer valve 4703 to the fluid delivery device 701.

One or more panels 704 may partially or completely bound the ablutionary system 700. In this example, the fluid delivery device 701 is a showerhead and the ablutionary system 700 is a shower system. The panels 704 define at least partially a shower enclosure. One or more of the panels 704 may include a wall of an ablutionary environment.

The ablutionary system 700 may be any suitable ablutionary system and it will be appreciated that the teaching of the present disclosure may be applied to other plumbing systems such as, for example, a fire sprinkler system.

This disclosure is intended to be read such that any separable features or elements of the disclosed invention, in any of its various aspects and embodiments, should be viewed as intended to be combinable unless the context clearly dictates otherwise. For example, any or all of the features of the fluid delivery device 1 as described above in relation to FIGS. 1-4 may be present in head portion 10′ of FIGS. 7A and 7B and/or the spray head 350 of FIG. 8 and/or the spray head 550 of FIG. 9.

A first aspect provides a fluid delivery device for use in an ablutionary system comprising: an inlet for receiving fluid from a fluid supply; one or more fluid delivery outlets in fluid communication with the inlet; and a switching device disposed between the inlet and the fluid delivery outlet(s), the switching device being operable to control fluid flow to the fluid delivery outlet(s); wherein the switching device is configured such that the switching device has a first operating mode in which there is a first fluid flow from the inlet to a first chamber leading to one or more of the fluid delivery outlets and a second operating mode in which there is a second fluid flow from the inlet to a second chamber leading to one or more of the fluid delivery outlets; wherein for a given fluid delivery outlet when the switching device is in the first operating mode the first fluid flow enters the given fluid delivery outlet from the first chamber in a first direction and/or at a first location and when the switching device is in the second operating mode the second fluid flow enters the given fluid delivery outlet from the second chamber in a second direction and/or at a second location; wherein the second direction is different from the first direction and/or the second location is different from the first location; and wherein during use of the fluid delivery device the switching device is caused to cycle between the first operating mode and the second operating mode.

During use of the fluid delivery device the switching device may be caused to continuously cycle between the first operating mode and the second operating mode.

The second direction may be different from the first direction by an angle of greater than or equal to 2°, greater than or equal to 5°, greater than or equal to 10°, greater than or equal to 15°, greater than or equal to 20° or greater than or equal to 30° and/or less than or equal to 10°,less than or equal to 15°, less than or equal to 20°, less than or equal to 30°, less than or equal to 40°, less than or equal to 60° or less than or equal to 75°.

The second location may be different from the first location by a distance of 2 cm or less, 1 cm or less or 0.5 cm or less. The second location may be different from the first location by a distance of at least 0.05 cm, at least 0.1 cm or at least 0.4 cm.

The first chamber may lead to two or more of the fluid delivery outlets. The second chamber may lead to two or more of the fluid delivery outlets.

The inlet and the switching device may both form part of a body of the fluid delivery device. The body may be a single piece. Alternately, the inlet and/or the switching device may be selectively coupled to the remainder of the body.

The fluid delivery device may comprise a first plate containing a first plurality of through holes each of which feed a respective one of the fluid delivery outlets.

The fluid delivery device may comprise a second plate containing: a second plurality of through holes each of which feed a respective one of the fluid delivery outlets; and a third plurality of through holes each of which fluidically connect a respective one of the first plurality of through holes to a respective one of the fluid delivery outlets.

The first plate and/or the second plate may be disc shaped or may take any other flattened, regular or irregular, geometric shape.

At least a selection of the fluid delivery outlets may receive flow from one of the second plurality of through holes at a different angle to which they receive flow from one of the third plurality of through holes.

Each of the fluid delivery outlets may receive flow from one of the second plurality of through holes at a different angle to which they receive flow from one of the third plurality of through holes.

The fluid delivery device may further comprise a spray face which includes the fluid delivery outlets.

The fluid delivery device may further comprise a cover which forms a rear external surface of the fluid delivery device opposite the spray face. The cover may be configured to couple to the body.

The spray face may constitute an outer surface of the second plate.

Alternately, the fluid delivery device may further comprise a spray plate configured to couple to a remainder of the fluid delivery device. For example, the spray plate configured to selectively couple to the body, the first plate, the second plate and/or the cover. The spray face may constitute an outer surface of a spray plate.

Items of the fluid delivery device which are configured to couple to one another may be configured to selectively couple to one another using any one or combination of: press-fit connectors; screws or other fastening means. Alternately, items of the fluid delivery device which are configured to couple to one another may be configured to permanently couple to one another, for example by welding, adhesive, glue, or alternate fixing means.

The first chamber may be further from the spray face than the second chamber. This may be measured by comparing distances, e.g. shortest distances, from respective centres of volume of the first chamber and second chamber to the spray face.

The fluid delivery device may be configured such that the first chamber is farther from the spray face than the second chamber is from the spray face, i.e., measuring distances, e.g. shortest distances, between each point of the first/second chamber to the spray face. For example, the first layer being farther from the spray face than the second layer is from the spray face means that, when measured from each and every point of the first and second layer, a distance, e.g. a shortest distance, from the first layer to the spray face is greater than a distance, e.g. a shortest distance, from the second layer to the spray face. The fluid delivery device may be configured such that all of the first chamber is farther from the spray face than all of the second chamber is from the spray face, i.e., measuring shortest distances between each point of the first/second chamber to the spray face. For example, all of the first layer being farther from the spray face than all of the second layer is from the spray face means that, when measured from each and every point of the first and second layer, a shortest distance from the first layer to the spray face is greater than a shortest distance from the second layer to the spray face.

The first spray plate may be parallel to the second spray plate.

In some embodiments, the first spray plate may not be parallel to the second spray plate.

The spray face may be substantially planar. Either or both the first spray plate and the second spray plate may, or may not, be parallel to the spray face.

In one embodiment, the fluid delivery device may be configured such that when the switching device is in the first operating mode, there is not the second fluid flow from the inlet to a second chamber and when the switching device is in the second operating mode, there is not the first fluid flow from the inlet to a second chamber.

The fluid delivery device may be configured such that when the switching device is in the first operating mode, fluid flow from the inlet to the first chamber is at a different flow rate to when the switching device is in the second operating mode.

The fluid delivery device may be configured such that when the switching device is in the first operating mode fluid flow from the inlet to the second chamber is at a different flow rate to when the switching device is in the second operating mode.

The fluid delivery device may be configured such that when the switching device is in the first operating mode there is no fluid flow from the inlet to the second chamber and/or when the switching device is in the second operating mode there is no fluid flow from the inlet to the second chamber.

The switching device may comprise: a switching device inlet; at least two switching device outlets, which each feed a respective one of the first chamber and second chamber; and a switching mechanism configured to cycle, e.g. to cycle continuously, between the first operating mode and the second operating mode, wherein in the first operating mode, flow is directed from the switching device inlet, through the switching mechanism to a first switching device outlet of the at least two switching device outlets to form the first fluid flow, and in the second operating mode, flow is directed from the switching device inlet, through the switching mechanism to a second switching device outlet of the at least two switching device outlets to form the second fluid flow.

The switching device inlet, switching mechanism and the at least two switching device outlets may be disposed in a common plane which may be substantially (or completely) perpendicular to a direction of fluid output from the one or more fluid delivery outlets. The direction of fluid output from the one or more fluid delivery outlets may be a mean average of volume output rate from the fluid delivery outlets.

The common plane may be substantially (or completely) parallel to one or more of; the spray face, the spray plate, the first plate, the second plate, or the cover.

The switching device may be configured such that it is stationary, relative to the remainder of the fluid delivery device, during cycling between the first operating mode and the second operating mode.

The switching device may be configured such that every part of the switching device is stationary, relative to the remainder of the fluid delivery device, during cycling between the first operating mode and the second operating mode.

One or more of the second plurality of through holes may be tilted, by an angle a, with respect to the third plurality of through holes such that for a given fluid delivery outlet, the first fluid flow enters the fluid delivery outlet in a different direction to that which the second fluid flow enters the fluid delivery outlet.

The angle a may be greater than or equal to 2°, greater than or equal to 5°, greater than or equal to 10°, greater than or equal to 15°, greater than or equal to 20° or greater than or equal to 30° and/or less than or equal to 10°, less than or equal to 15°, less than or equal to 20°, less than or equal to 30°, less than or equal to 40°, less than or equal to 60° or less than or equal to 75°.

The switching device may comprise an antechamber fluidically connected to the first chamber by a first channel and fluidically connected to the second chamber by a second channel.

The switching device may comprise a first feedback loop which provides a path for fluid flow from the first channel to the antechamber.

The switching device may comprise a second feedback loop which provides a path for fluid flow from the second channel to the antechamber.

The switching device may be configured such that: fluid flow from the first feedback loop disrupts fluid flow to the first channel, thereby switching the switching device from its first operating mode into its second operating mode; and fluid flow from the second feedback loop disrupts fluid flow to the second channel, thereby switching the switching device from its second operating mode into its first operating mode.

The switching device may comprise a movable element configured to block, at least partially, and unblock, at least partially, in a continuous cycle fluid flow from the inlet to the first chamber and fluid flow from the inlet to the second chamber such that, in use, the switching device may cycle, e.g. continuously cycle, between the first operating mode and the second operating mode.

The movable element may be rotatable and may be a turbine.

The movable element may be driven solely or primarily by fluid flow from the inlet.

Alternately, the movable element may be motorised and/or electrically powered.

The fluid delivery device may be configured such that when the switching device is in the first operating mode or the second operating mode there is a third fluid flow from the inlet to one or more further fluid delivery outlets.

The fluid delivery device may comprise, or consist essentially of, a spray head, such as those typically found on a shower or a faucet.

The fluid may comprise water.

The fluid delivery device may comprise a conduit assembly including: a conduit configured to convey a fluid stream; a flow constrictor configured to constrict flow of the fluid stream along the conduit, thereby producing, in use, a pressure drop in the fluid stream downstream of the flow constrictor; one or more air induction channels for conveying a stream of air from outside the conduit into the conduit at one or more locations downstream of the flow constrictor; and an air induction channel closure means operable between a first state, in which one or more of the air induction channels are open and a second state, in which one or more of the air induction channels are closed; wherein: when the air induction channel closure means is in the first state, the pressure drop in the fluid stream downstream of the flow constrictor causes one or more streams of air to be drawn along the open air induction channel(s), wherein the one or more streams of air mix with the fluid stream in the conduit to form an aerated fluid stream; and when the air induction channel closure means is in the second state, no streams of air are conveyed along the closed air induction channel(s) from outside the conduit into the conduit.

The air induction channel closure means may be operable to translate relative to the conduit. For instance, the air induction channel closure means may be operable to translate relative to the conduit in a direction parallel to a longitudinal axis of the conduit.

In an implementation, the air induction channel closure means may comprise a sleeve.

The air induction channel closure means may comprise a grip means to facilitate manual actuation between the first state and the second state.

The grip means may comprise a ridge. The ridge may have a crescent or arcuate shape at least in part, though other shapes are foreseeable.

The conduit assembly may be made from two parts, e.g. a first part and a second part, which are configured to couple selectively to one another.

Either or both of the first part and the second part may be substantially tubular in shape.

An end of the first part proximal to the second part may form a reduced radius portion which has a smaller external radius than a remainder of the first part.

An end of the second part proximal to the first part may form an increased radius portion which has a larger internal radius than a remainder of the second part.

In alternative embodiments, the conduit assembly may be made from more or fewer parts.

One or more threaded portions may be disposed on an external surface of the reduced radius portion and/or on an internal surface of the increased radius portion.

The first part may be configured to fit at least partially within and engage the second part to selectively couple the first and second parts of the conduit.

The flow constrictor may form one end of a hollow insert.

The conduit assembly may be configured such that the hollow insert is located within the first part. For example, the hollow insert may be located within the reduced radius portion.

The hollow insert may include a radially projecting rim distal to the flow constrictor.

The conduit assembly may be configured such that the rim is sandwiched between the first part and the second part.

The one or more air induction channels may include a first set of air induction passages which perforate the first part of the conduit.

The one or more air induction channels may include a second set of air induction passages which perforate the hollow insert.

One or more of the second set of air induction passages may be arranged to receive air from a respective one of the first set of air induction passages and provide air to an interior of the hollow insert.

The first set and/or the second set of air induction passages may include one or more air induction passages. For example, the first set of air induction passages may include greater than or equal to 2, greater than or equal to 4, greater than or equal to 8, greater than or equal to 10 or greater than or equal to 16 air induction passages and/or less than or equal to 32, less than or equal to 18, less than or equal to 16, less than or equal to 10 or less than or equal to 8 air induction passages. The second set of air induction passages may include greater than or equal to 2, greater than or equal to 4, greater than or equal to 8, greater than or equal to 10 or greater than or equal to 16 air induction passages and/or less than or equal to 32, less than or equal to 18, less than or equal to 16, less than or equal to 10 or less than or equal to 8 air induction passages.

The first set of air induction passages may be regularly distributed around a circumference of the first part (optionally the reduced radius portion). The second set of air induction passages may be regularly distributed around a circumference of the second part (optionally the increased radius portion). In alternative embodiments, the air induction passages may be arranged irregularly.

The conduit assembly may be configured such that air may enter the hollow insert downstream of the flow constrictor. For example, the conduit assembly may be configured such that air may enter the hollow insert immediately downstream of the flow constrictor.

The conduit assembly may be configured such that when the air induction channel closure means is in the first state, a gap is present between a front end of the air induction channel closure means, proximal to the second part, and the second part, thereby opening up the air induction channels.

The conduit assembly may be configured such that when the air induction channel closure means is in the second state, the front end of the air induction channel closure means contacts the second part, thereby sealing the front end of the air induction channel closure means against the second part.

Two sealing members may be disposed on an external surface of the reduced radius portion on either side of the first set of air induction passages. A first of these two sealing members, distal from the second part, may act to help limit or prevent air from entering the conduit via the gap between a rear end of the air induction channel closure means and the first part.

An internal radius of the air induction channel closure means may increase towards the front end of the air induction channel closure means. When the air induction channel closure means is in the first state, there may be a clearance between a second of the two sealing members and the air induction channel closure means.

When the air induction channel closure means is in the second state, each of the two sealing members may inhibit or prevent fluid (e.g., air or water) from flowing between the reduced radius portion and the air induction channel closure means.

When the air induction channel closure means is in the second state, the second sealing member may act as a secondary seal to limit or prevent air from entering into the conduit between the front end of the air induction channel closure means and the second part.

The fluid delivery device may comprise or essentially consist of a handheld shower or a fixed overhead shower.

The fluid delivery device may comprise a spray head for a shower.

The conduit assembly may be integrated into a support pipe that can fix the fluid delivery device with respect to a shower enclosure in which the fluid delivery device is installed.

The flow constrictor may comprise a section of the conduit wherein a cross-sectional area progressively narrows in a direction of the fluid stream.

The conduit may be perforated by one or more air induction channels for conveying a stream of air from outside the conduit into the conduit.

The air induction channel closure means may comprise a movable plate. The moveable plate may be operable to actuate the conveyance of air along the one or more air induction channels.

The movable plate may form a rear external surface of the spray head.

The movable plate may be operable to move with respect to the one or more air induction channels. For example, the movable plate may be operable to rotate around an axis of the fluid delivery device. The axis may pass through and be aligned substantially perpendicular to a center of a spray face of the spray head.

When the air induction channel closure means is in the first state, the movable plate may be arranged such that the one or more through thickness apertures at least partially align with the one or more air induction channels thereby enabling airflow to the one or more air induction channels. As such, in this state, the air induction channels may be open.

When the air induction channel closure means is in the second state, the one or more through thickness apertures may be misaligned with the one or more air induction channels, thereby preventing or substantially reducing airflow to the one or more air induction channels. As such, in this state, the one or more air induction channels may be substantially or completely closed.

The movable plate may include a grip to enable user actuation of the movable plate between the first state and the second state.

A second aspect provides a conduit assembly comprising: a conduit configured to convey a fluid stream; a flow constrictor configured to constrict flow of the fluid stream along the conduit, thereby producing, in use, a pressure drop in the fluid stream downstream of the flow constrictor; one or more air induction channels for conveying a stream of air from outside the conduit into the conduit at one or more locations downstream of the flow constrictor; and an air induction channel closure means operable between a first state, in which one or more of the air induction channels are open and a second state, in which one or more of the air induction channels are closed; wherein: when the air induction channel closure means is in the first state, the pressure drop in the fluid stream downstream of the flow constrictor causes one or more streams of air to be drawn along the open air induction channel(s), wherein the one or more streams of air mix with the fluid stream in the conduit to form an aerated fluid stream; and when the air induction channel closure means is in the second state, no streams of air are conveyed along the closed air induction channel(s) from outside the conduit into the conduit.

The conduit may be configured to convey the fluid stream to a fluid delivery device or through a portion of a fluid delivery device. The conduit may be upstream of a fluid delivery device. The conduit may be disposed at least partially within a fluid delivery device.

The air induction channel closure means may be operable to translate relative to the conduit. For instance, the air induction channel closure means may be operable to translate relative to the conduit in a direction parallel (or substantially parallel) to a longitudinal axis of the conduit.

In an implementation, the air induction channel closure means may comprise a sleeve.

The air induction channel closure means may comprise a grip means to facilitate manual actuation between the first state and the second state.

The grip means may comprise a ridge. The ridge may have a crescent or arcuate shape at least in part. In alternative embodiments, other shapes for the ridge are foreseeable.

The conduit assembly may be made from two parts, e.g. a first part and a second part, which are configured to couple selectively to one another (though alternative embodiments may include more or fewer parts).

Either or both of the first part and the second part may be substantially tubular in shape.

An end of the first part proximal to the second part may form a reduced radius portion which has a smaller external radius than a remainder of the first part.

An end of the second part proximal to the first part may form an increased radius portion which has a larger internal radius than a remainder of the second part.

One or more threaded portions may be disposed on an external surface of the reduced radius portion and/or on an internal surface of the increased radius portion.

The first part may be configured to fit at least partially within and engage the second part to couple selectively the first and second parts of the conduit.

The flow constrictor may form one end of a hollow insert.

The conduit assembly may be configured such that the hollow insert is located within the first part. For example, the hollow insert may be located within the reduced radius portion.

The hollow insert may include a radially projecting rim distal to the flow constrictor.

The conduit assembly may be configured such that the rim is sandwiched between the first part and the second part.

The one or more air induction channels may include a first set of air induction passages which at least partially perforate the first part of the conduit.

The one or more air induction channels may include a second set of air induction passages which at least partially perforate the hollow insert.

One or more of the second set of air induction passages may be arranged to receive air from a respective one of the first set of air induction passages and provide air to an interior of the hollow insert.

The first set and/or the second set of air induction passages may include one or more air induction passages. For example, the first set of air induction passages may include greater than or equal to 2, greater than or equal to 4, greater than or equal to 8, greater than or equal to 10 or greater than or equal to 16 air induction passages and/or less than or equal to 32, less than or equal to 18, less than or equal to 16, less than or equal to 10 or less than or equal to 8 air induction passages. The second set of air induction passages may include greater than or equal to 2, greater than or equal to 4, greater than or equal to 8, greater than or equal to 10 or greater than or equal to 16 air induction passages and/or less than or equal to 32, less than or equal to 18, less than or equal to 16, less than or equal to 10 or less than or equal to 8 air induction passages.

The first set of air induction passages may be regularly distributed around a circumference of the first part (optionally the reduced radius portion). The second set of air induction passages may be regularly distributed around a circumference of the second part (optionally the increased radius portion). In alternative embodiments, the air induction passages may be distributed irregularly.

The conduit assembly may be configured such that air may enter the hollow insert downstream of the flow constrictor. For example, the conduit assembly may be configured such that air may enter the hollow insert immediately downstream of the flow constrictor.

The conduit assembly may be configured such that when the air induction channel closure means is in the first state, a gap is present between a front end of the air induction channel closure means, proximal to the second part, and the second part, thereby opening up the air induction channels.

The conduit assembly may be configured such that when the air induction channel closure means is in the second state, the front end of the air induction channel closure means contacts the second part, thereby sealing the front end of the air induction channel closure means against the second part.

Two sealing members may be disposed on an external surface of the reduced radius portion on either side of the first set of air induction passages. A first of these two sealing members, distal from the second part, may act to limit or prevent air from entering the conduit via the gap between a rear end of the air induction channel closure means and the first part.

An internal radius of the air induction channel closure means may increase towards the front end of the air induction channel closure means. When the air induction channel closure means is in the first state, there may be a clearance between a second of the two sealing members and the air induction channel closure means.

When the air induction channel closure means is in the second state, either or both of the two sealing members may inhibit or prevent fluid (e.g., air or water) from flowing between the reduced radius portion and the air induction channel closure means.

When the air induction channel closure means is in the second state, the second sealing member may act as a secondary seal to limit or prevent air from entering into the conduit between the front end of the air induction channel closure means and the second part.

The conduit assembly may be integrated into a support pipe configured to fix a fluid delivery device with respect to a shower enclosure in which the fluid delivery device is installed.

The conduit assembly may be configured to be integrated into a spray head of a fluid delivery device.

The flow constrictor may comprise a section of the conduit wherein a cross-sectional area progressively narrows in a direction of the fluid stream.

The conduit may be perforated by one or more air induction channels for conveying a stream of air from outside the conduit into the conduit.

The air induction channel closure means may comprise a movable plate. The moveable plate may be operable to actuate the conveyance of air along the one or more air induction channels.

The movable plate may form a rear external surface of the spray head.

The movable plate may be operable to move with respect to the one or more air induction channels. For example, the movable plate may be operable to rotate around an axis of the fluid delivery device. The axis may pass through and be aligned substantially perpendicular to a center of a spray face of the spray head.

When the air induction channel closure means is in the first state, the movable plate may be arranged such that the one or more through thickness apertures at least partially align with the one or more air induction channels thereby enabling airflow to the one or more air induction channels. As such, in this state, the air induction channels may be open.

When the air induction channel closure means is in the second state, the one or more through thickness apertures may be misaligned with the one or more air induction channels thereby preventing or reducing airflow to the one or more air induction channels. As such, in this state, the one or more air induction channels may be closed or substantially closed.

The movable plate may include a grip to enable user actuation of the movable plate between the first state and the second state.

A third aspect provides a fluid delivery device or a plumbing system comprising a conduit assembly according to the second aspect.

A fourth aspect provides a plumbing system comprising: a fluid delivery device according to the first aspect or a fluid delivery device according to the second aspect; and a fluid supply pipe configured to connect fluidically the fluid delivery device to a fluid source.

The fluid source may include a mixer valve or an instantaneous water heater.

The plumbing system may be an ablutionary system, e.g. a shower system.

The ablutionary system may be disposed at least partially within a shower and/or bath enclosure.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

It will be understood that the invention is not limited to the embodiments described above and various modifications and improvements can be made without departing from the concepts described herein. Except where mutually exclusive, any of the features may be employed separately or in combination with any other features and the disclosure extends to and includes all combinations and sub-combinations of one or more features described herein.

1. A fluid delivery device comprising:
an inlet;
one or more fluid delivery outlets in fluid communication with the inlet; and
a switching device disposed between the inlet and the one or more fluid delivery outlets, the switching device controlling fluid flow to the fluid delivery outlet(s);
wherein the switching device has a first operating mode in which there is a first fluid flow from the inlet to a first chamber leading to one or more of the fluid delivery outlets, and a second operating mode in which there is a second fluid flow from the inlet to a second chamber leading to one or more of the fluid delivery outlets;
wherein for a given fluid delivery outlet when the switching device is in the first operating mode, the first fluid flow enters the given fluid delivery outlet from the first chamber in a first direction and/or at a first location, and when the switching device is in the second operating mode, the second fluid flow enters the given fluid delivery outlet from the second chamber in a second direction and/or at a second location;
wherein the second direction is different from the first direction and/or the second location is different from the first location; and wherein the switching device cycles between the first operating mode and the second operating mode.

2. The fluid delivery device of claim 1, wherein the second direction is different from the first direction by an angle of greater than or equal to 2° and/or less than or equal to 75°.

3. The fluid delivery device of claim 1, wherein the second location is different from the first location by a distance of 2 cm or less and/or the second location is different from the first location by a distance of at least 0.05 cm.

4. The fluid delivery device of claim 1, wherein the first chamber leads to two or more of the fluid delivery outlets and/or the second chamber leads to two or more of the fluid delivery outlets.

5. The fluid delivery device of claim 1, further comprising a spray face which includes the fluid delivery outlets.

6. The fluid delivery device of claim 5, wherein the first chamber is further from the spray face than the second chamber.

7. The fluid delivery device of claim 1, wherein the switching device includes:
a switching device inlet;
at least two switching device outlets, which each feed a respective one of the first chamber and second chamber; and
a switching mechanism cycling between the first operating mode and the second operating mode,
wherein in the first operating mode, flow is directed from the switching device inlet, through the switching mechanism to a first switching device outlet of the at least two switching device outlets to form the first fluid flow, and in the second operating mode, flow is directed from the switching device inlet, through the switching mechanism to a second switching device outlet of the at least two switching device outlets to form the second fluid flow.

8. The fluid delivery device of claim 7, wherein the switching device includes an antechamber fluidically connected to the first chamber by a first channel and fluidically connected to the second chamber by a second channel.

9. The fluid delivery device of claim 8, wherein the switching device includes a first feedback loop which provides a path for fluid flow from the first channel to the antechamber and a second feedback loop which provides a path for fluid flow from the second channel to the antechamber.

10. The fluid delivery device of claim 9, wherein fluid flow from the first feedback loop disrupts fluid flow to the first channel, thereby switching the switching device from its first operating mode into its second operating mode; and fluid flow from the second feedback loop disrupts fluid flow to the second channel, thereby switching the switching device from its second operating mode into its first operating mode.

11. The fluid delivery device of claim 1, further comprising a conduit assembly including:
a conduit;
a flow constrictor constricting flow of a fluid stream along the conduit, thereby producing, in use, a pressure drop in the fluid stream downstream of the flow constrictor;
one or more air induction channels conveying a stream of air from outside the conduit into the conduit at one or more locations downstream of the flow constrictor; and
an air induction channel closure having a first state in which one or more of the air induction channels are open, and having a second state in which one or more of the air induction channels are closed;
wherein:
when the air induction channel closure is in the first state, the pressure drop in the fluid stream downstream of the flow constrictor causes one or more streams of air to be drawn along the open one or more air induction channels, wherein the one or more streams of air mix with the fluid stream in the conduit to form an aerated fluid stream; and
when the air induction channel closure is in the second state, no streams of air are conveyed along the closed one or more air induction channels from outside the conduit into the conduit.

12. The fluid delivery device of claim 11, wherein the air induction channel closure translates relative to the conduit.

13. A conduit assembly comprising:
a conduit;
a flow constrictor constricting flow of a fluid stream along the conduit, thereby producing, in use, a pressure drop in the fluid stream downstream of the flow constrictor;
one or more air induction channels conveying a stream of air from outside the conduit into the conduit at one or more locations downstream of the flow constrictor; and
an air induction channel closure having a first state in which one or more of the air induction channels are open, and having a second state in which one or more of the air induction channels are closed;
wherein:
when the air induction channel closure is in the first state, the pressure drop in the fluid stream downstream of the flow constrictor causes one or more streams of air to be drawn along the open one or more air induction channels, wherein the one or more streams of air mix with the fluid stream in the conduit to form an aerated fluid stream; and
when the air induction channel closure is in the second state, no streams of air are conveyed along the closed one or more air induction channels from outside the conduit into the conduit.

14. The conduit assembly of claim 13, wherein the air induction channel closure translates relative to the conduit.

15. A fluid delivery device or a plumbing system comprising a conduit assembly according to claim 13.

16. A plumbing system comprising:
a fluid delivery device according to claim 1; and
a fluid supply pipe fluidically connecting the fluid delivery device to a fluid source.

17. The plumbing system of claim 16, wherein the fluid source includes a mixer valve or an instantaneous water heater.
